(19) United States
(12) Patent Application Publication
(10) Pub. No.: US 2005/0053015 A1
(43) Pub. Date: Mar. 10, 2005

(54) Method and apparatus for enhancing transfer rate using DLP and multi channels in wireless LAN using PCF and DCF

(75) Inventors: Ho Jin, Yongin-si (KR); Seong-hee Lee, Seoul (KR); Kyung-ik Cho, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/892,444

(22) Filed: Jul. 16, 2004

(30) Foreign Application Priority Data
Aug. 14, 2003 (KR) 10-2003-0056595

(51) Int. Cl. H04L 12/28

(52) U.S. Cl. 370/254

(57) ABSTRACT

A wireless network communication method and apparatus for enhancing a data transfer rate by using a direct link protocol (DLP) and multi channels during a point coordination function (PCF) period in wireless network communications in which an access point is employed in an infrastructure mode using both a contention-free period and a contention period. The wireless network communication method of the present invention including transmitting/receiving data among stations supporting a direct link, during a given duration, through the direct link using an independent channel; transmitting/receiving data among stations other than the stations supporting the direct link, during the duration, in a specific mode corresponding to the contention-free or contention period; switching the DLP stations to a primary channel after the given duration; and transmitting/receiving data among all stations including the DLP stations, during the remaining duration, in a specific mode corresponding to the contention-free or contention period.

### BACKGROUND OF THE INVENTION

This application claims the priority of Korean Patent Application No. 10-2003-0056595 filed on Aug. 14, 2003, in the Korean Intellectual Property Office, the disclosure of which is incorporated herein in its entirety by reference.

1. Field of the Invention

The present invention relates to a method of enhancing a transfer rate in wireless communications, and more particularly, to a wireless network communication method and apparatus for enhancing a data transfer rate by using a direct link protocol (DLP) and multi channels during a point coordination function (PCF) period in wireless network communications in which an access point (AP) is employed in an infrastructure mode using both a contention-free period and a contention period.

2. Description of the Related Art

Recently, as networks are increasingly being constructed in a wireless manner, and as requests for the transfer of large volumes of multimedia data continue to rise, there is a need for an effective transfer method in wireless local area networks (LANs). There are two methods for improving the performance of wireless LANs with regard to the transfer of various multimedia data. The first is a method of ensuring the quality of service (QoS) in a Media Access Control (MAC) level in order to effectively transmit data within a given time period over conventional wireless LAN schemes in which a plurality of stations share a single channel. In this regard, the IEEE 802.11e group makes an effort to unify standards for improving QoS. The second is a method of increasing bandwidth by allowing stations to physically acquire channels using multi channels rather than a single channel in a basic service set (BSS).

A conventional IEEE 802.11 MAC protocol employs a carrier sense multiple access with collision avoidance (CSMA/CA) protocol in which a plurality of nodes share a single channel. The method of sharing a single channel includes a distributed coordination function (DCF) scheme in which a random back-off algorithm is employed to reduce collision probability. In addition, there is a point coordinator function (PCF) scheme in which an AP serving as a point coordinator is operated to specify a channel sequence of stations according to polling scheduling.

In IEEE 802.11 ad-hoc mode, a channel can be shared among the nodes through contention in DCF mode since there is no AP for managing and controlling nodes. On the other hand, in IEEE 802.11 infrastructure mode, not only the DCF mode but also the PCF mode in which an AP serving as a point coordinator enables the use of a channel without contention can be used.

FIG. 1 illustrates a process of transferring data among stations based on DCF rules. A sending station STA1 110 sends a Request to Send (RTS) frame 111 to a receiving station STA2 120 present in the same BSS before transferring data 112 to STA2 120, in order to determine whether STA2 120 can receive data 112. STA2 120 sends a clear-to-send (CTS) frame 121, i.e. a control frame, which notifies STA1 110 that STA2 120 can receive the data 112 and allows STA1 110 to transfer the data. Then, the station STA1 110 sends the data to STA2 120. In this process, Network Allocation Vectors (NAVs) are set up in the remaining stations STA3 130 except for STA1 110 and STA2 120 present in the same BSS, and stations STA3 130 do not send data by considering the channel as being busy during NAV periods 131 and 132.

Meanwhile, FIG. 2 illustrates a process of transferring data among stations according to PCF rules. In general, such a PCF is used along with DCF. If a PCF period is completed, a DCF period is started. Both the PCF and DCF periods become a single repetition period. In this figure, D1, D2, and the like indicate frames sent by a point coordinator, while U1, U2, and the like indicate frames sent by each station that has received a poll. The point coordinator transmits a beacon, which initiates a contention-free period complying with the PCF rules. Polling through which the point coordinator asks whether a station has data to send is performed in a round-robin mode for each station. If the point coordinator performs the polling, a station that received the polling sends data and acknowledgement (ACK) to the point coordinator. Then, the point coordinator transmits the data and ACK to a station that will receive them and polls the station that will receive the data. The polled station sends an ACK together with data, if any, back to the point coordinator. In such a manner, data are transmitted/received among stations during the contention-free period.

IEEE 802.11e has been proposed to supplement a wireless LAN standard that is weak in the provision of QoS, as in IEEE 802.11. In IEEE 802.11e, the AP basically manages channel use time and the transfer sequence of nodes to enhance QoS therein. That is, a priority is assigned to each node according to the type of data that each node will send, so that a polling sequence is determined based on priority. Otherwise, priority is determined through channel contention. Further, each node using a channel is assigned the channel use time called transmission opportunity (TXOP) by the AP channel, and transfers data during this period. Thus, a disadvantage that only a single frame was transmitted in the IEEE 802.11 standard can be overcome and multi-frame transmission can be supported.

Even though network throughput was improved through the multi-frame transmission, there is a problem of network performance efficiency because the frames still pass through the AP in infrastructure mode. A direct link protocol (DLP) has been proposed to improve network performance through direct communication among the nodes without intervention of the AP. According to the DLP specified in IEEE 802.11e, stations perform data communication using an independent link without the intervention of the AP while transmitting/receiving data, in a case where the infrastructure mode is used in a BSS. Further, the DLP corresponds to a method of stably managing channels using the AP and allowing the maximum throughput to be provided by causing direct communications to be made among the stations. According to this DLP, since data does not have to pass through the AP while being transmitted, it is possible to enhance transfer efficiency by reducing transmission time, propagation time and AP MAC processing time.

To perform communication using DLP, a DLP setup process is first required. This setup process will be now explained with reference to FIG. 3. QSTA-1 310 that is a DLP requesting station sends a DLP request frame to an AP 320 (S1a). At this time, the DLP request frame contains information on a data transfer rate, the capability of the station, and the like. Next, the AP simply forwards the DLP request frame to QSTA-2 330 that is a receiving station (S1b). QSTA-2 330 confirms the DLP request frame received from the AP 320 and then transmits a DLP response frame, which contains information on whether to participate in a direct link 340, to the AP 320 (S2a). The DLP response frame contains information on the status code informing the results of the DLP request, the data transfer rate, the capability of the station, and the like. Finally, the AP 320 simply forwards the DLP response frame to QSTA-1 310 (S2b). A series of these four processes is called a four-handshake process of DLP. For reference, the structures of the DLP request frame and the DLP response frame in the related art are shown in FIG. 4.

In conventional techniques by which a plurality of stations share a single channel, a critical point is how the plurality of stations efficiently share the maximum transfer rate of the single channel (e.g., 54 Mbps in case of 802.11a). In the transfer of large volumes of multimedia data, however, QoS cannot be adequately ensured by using only conventional technology. Accordingly, there have been developed many MAC algorithms in view of QoS so as to transfer data within a given period of time. DLP is one of these methods, which directly transfers data through a direct link without passing through an AP under the condition that peer to peer (P2P) communications should be made after a DLP is set up. Even through DLP is used, however, it is difficult to make use of the advantages of the direct link if contention is increased due to the presence of many stations in a BSS.

Therefore, there is a need for a method that enables efficient communication as well as makes use of the advantages of DLP in a case where a plurality of stations are present in a wireless LAN. To this end, there is proposed a new mechanism for a method of using an independent DLP channel within a BSS in which PCF and DCF are used.

### SUMMARY OF THE INVENTION

The present invention addresses the aforementioned problems. An aspect of the present invention is to provide an apparatus and method for reducing contentions among stations using PCF and DCF.

Another aspect of the present invention is to provide a compatible wireless environment in which stations operate either according to PCF or DCF rules by using a suitable independent direct link.

A further aspect of the present invention is to provide a new DLP frame format necessary for a compatible wireless environment.

Consistent with an aspect of the present invention, there is provided a wireless network communication method, which comprises (1) transmitting/receiving data among stations supporting a direct link, during a given duration, through the direct link using an independent channel; (2) transmitting/receiving data among stations other than the stations supporting the direct link, during the duration, in a specific mode corresponding to the contention-free or contention period; (3) switching the stations supporting the direct link to a primary channel after the given duration; and (4) transmitting/receiving data among all stations including the stations supporting the direct link, during the remaining duration, in a specific mode corresponding to the contention-free or contention period.

Consistent with another aspect of the present invention, there is provided a communication station, which comprises a channel-switching module that switches an existing channel to an independent channel by writing a new channel number into a DLP request frame and a MAC frame-generating module that generates a predetermined MAC frame including the DLP request frame.

Consistent with a further aspect of the present invention, there is provided an access point, which comprises a polling list-managing module that provides sequential polling to the stations based on a polling list, a channel list-managing module that manages a list of available channels through periodical channel condition analysis and allocates an independent channel to a station which perform communications through a direct link, a channel number-writing module that determines whether there are available channels based on the channel list and writes the available channels into a DLP request frame, and a point coordinator that receives frames to be sent to the DLP stations from stations present in a primary channel and performs buffering and management for the received frames.

The present invention operates according to PCF/DCF of a BSS. In a case where the BSS uses only the DCF, a DLP performs a direct link to the BSS using the DLP and then contends with other stations in the BSS. If the DLP station has lost the contention, it does not wait for a NAV period but transmits and receives data to and from the DLP stations using an independent channel. Alternatively, if the DLP station has won the contention, the DLP station broadcasts a duration, which will be used to transmit and receive data among the DLP stations in the independent channel, to other stations and then transmits and receives the data through the independent DLP channel during the duration. During the duration (DLP NAV), other stations operate according to the DCF rules. After the duration (DLP NAV), the DLP stations also return to a primary channel and all the stations operate according to DCF rules.

On the other hand, in the event that the BSS uses both PCF and DCF, the DLP stations communicate with one another via independent DLP channels in a PCF period and then again return to the primary channel. If the time point when the DLP stations return to the primary channel is within the PCF period, the DLP stations operate according to PCF rules during the remaining PCF period and operate according to DCF rules during the DCF period. Alternatively, if the time point when the DLP stations return to the primary channel is within the DCF period, the DLP stations operate according to the DCF rules since then. If there are any data to be sent among the DLP stations in a period when they operate according to the DCF rules, the DLP stations operate in the remaining DCF period according to the same manner as the case where the BSS uses only the DCF.

The direct link communications in the present invention means a method for transmitting and receiving data directly among stations without passing through an AP in wireless communications in infrastructure mode using the AP. The direct link communications include communications using DLP specified in IEEE 802.11e. Hereinafter, communications using the DLP will be described as an example of the direct link communications.

### BRIEF DESCRIPTION OF THE DRAWINGS

The above and other aspects, features and advantages of the present invention will become apparent from the following description of exemplary embodiments given in conjunction with the accompanying drawings, in which:

FIG. 1 illustrates a process of transferring data among stations according to DCF rules in the related art;

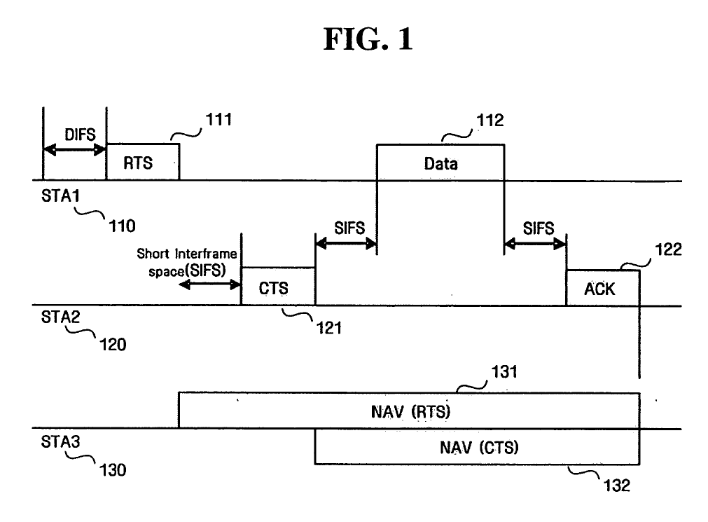

FIG. 2 illustrates a process of transferring data among stations according to PCF rules in the related art;

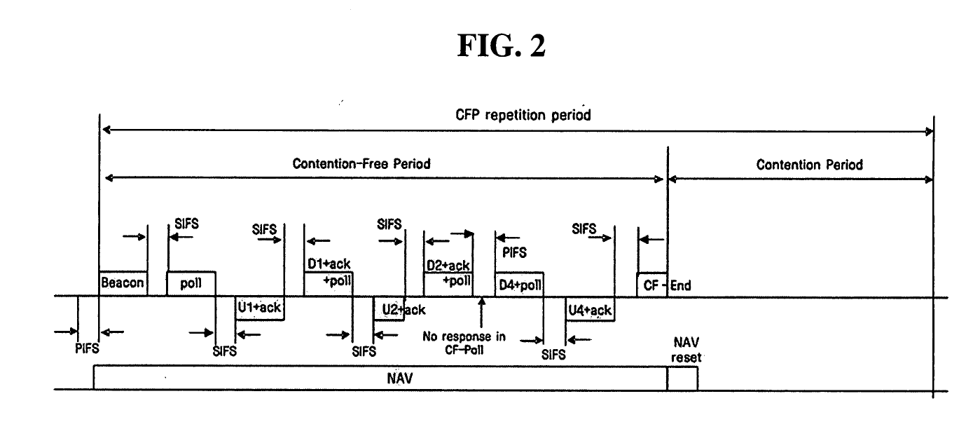

FIG. 3 illustrates a four-handshake process corresponding to a DLP setup process;

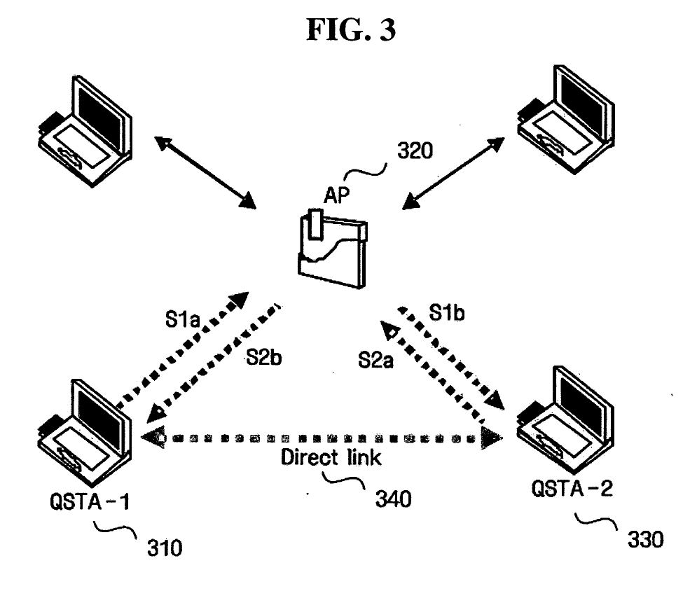

FIG. 4 shows the structures of various DLP MAC frames in the related art;

FIG. 5 is a block diagram illustrating the configuration of a DLP station for implementing an exemplary embodiment of the present invention;

FIG. 6 shows the structures of various DLP MAC frames consistent with the present invention;

FIG. 7 shows the structure of an association request frame;

FIG. 8 is a block diagram illustrating the configuration of an AP for implementing an exemplary embodiment of the present invention;

FIG. 9 is a flowchart illustrating a modified four-handshake process for implementing an exemplary embodiment of the present invention;

FIG. 10 is a graph showing a data transfer process for each station with the passage of time in a state where only DCF is used;

FIG. 11 is a flowchart illustrating the steps of the process shown in FIG. 10;

FIG. 12 shows a data transfer process in which a time point where a BSS returns to a primary channel after using a DLP channel that is within a PCF period, in a case where both PCF and DCF are used;

FIG. 13 shows a data transfer process in which a time point where the BSS returns to the primary channel after using the DLP channel that is within a DCF period, in a case where both PCF and DCF are used;

FIG. 14 is a flowchart illustrating the steps of the process shown in FIG. 12; and

FIG. 15 is a flowchart illustrating the steps of the process shown in FIG. 13.

### DETAILED DESCRIPTION OF THE INVENTION

Hereinafter, exemplary embodiments of the present invention will be described in detail with reference to the accompanying drawings.

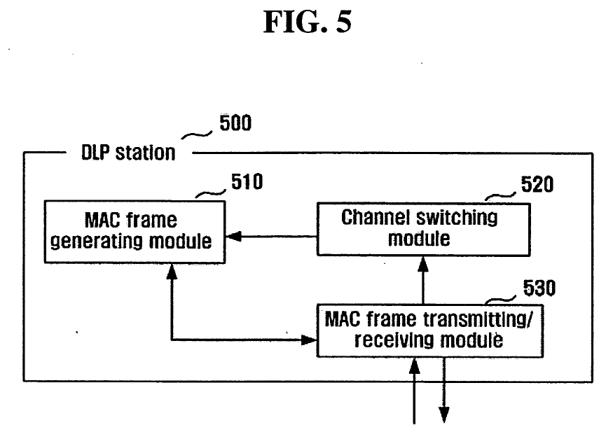

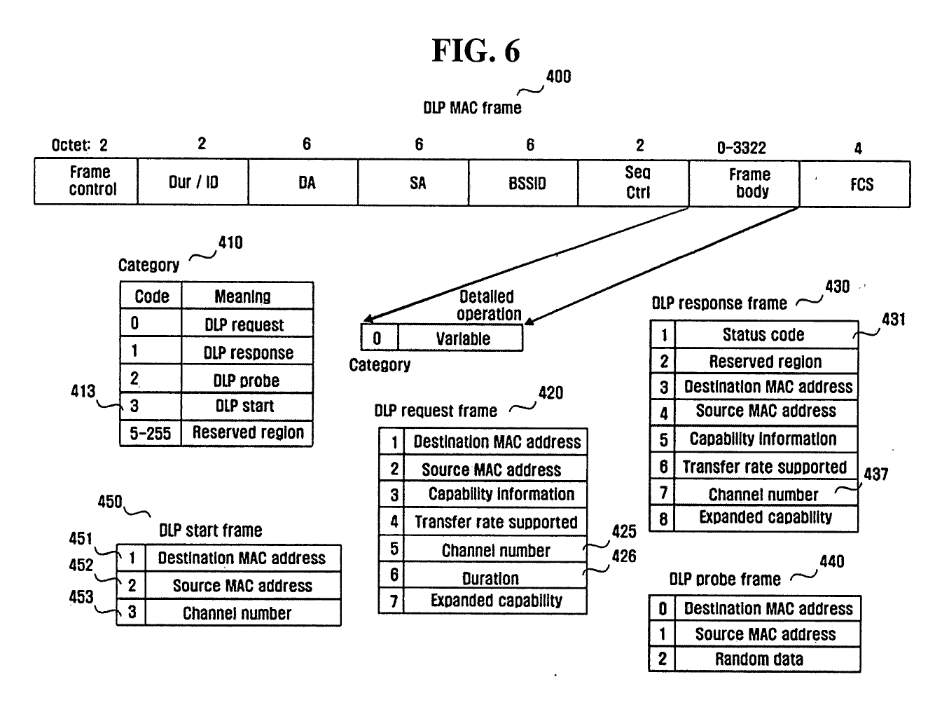

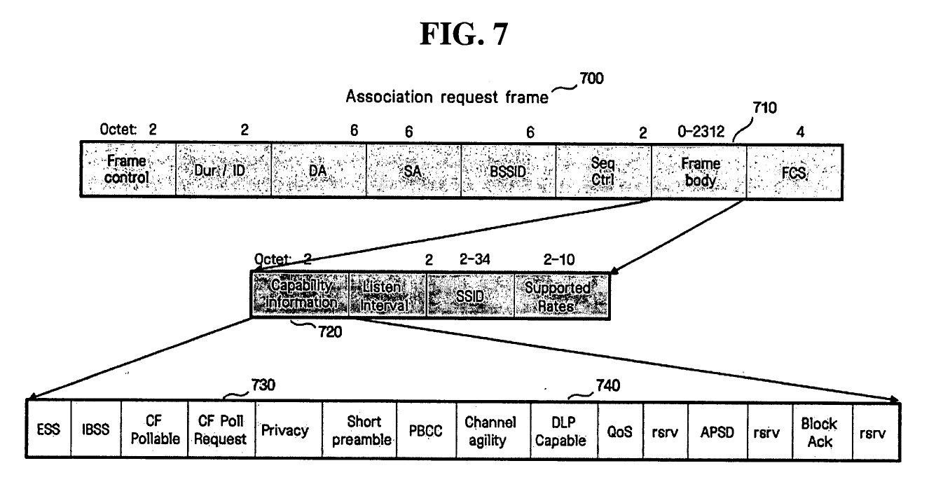

FIG. 5 shows the configuration of a DLP station for implementing the present invention. As shown in this figure, the DLP station 500 may comprise a MAC frame-generating module 510, a channel-switching module 520 and a MAC frame-transmitting/receiving module 530. The MAC frame-generating module 510 functions to generate a DLP request frame, a DLP response frame, a DLP probe frame, a DLP start frame, an association request frame and a data frame to be transmitted/received. The structures of the frames will be described later with reference to FIGS. 6 and 7.

The channel-switching module 520 functions to switch a channel by writing a new channel number into a channel number field of the DLP request frame when it is necessary to switch from a primary channel to a new channel assigned by an AP for direct link communications, and vice versa.

The MAC frame-transmitting/receiving module 530 functions to transmit/receive a variety of the frames generated in the MAC frame-generating module 510.

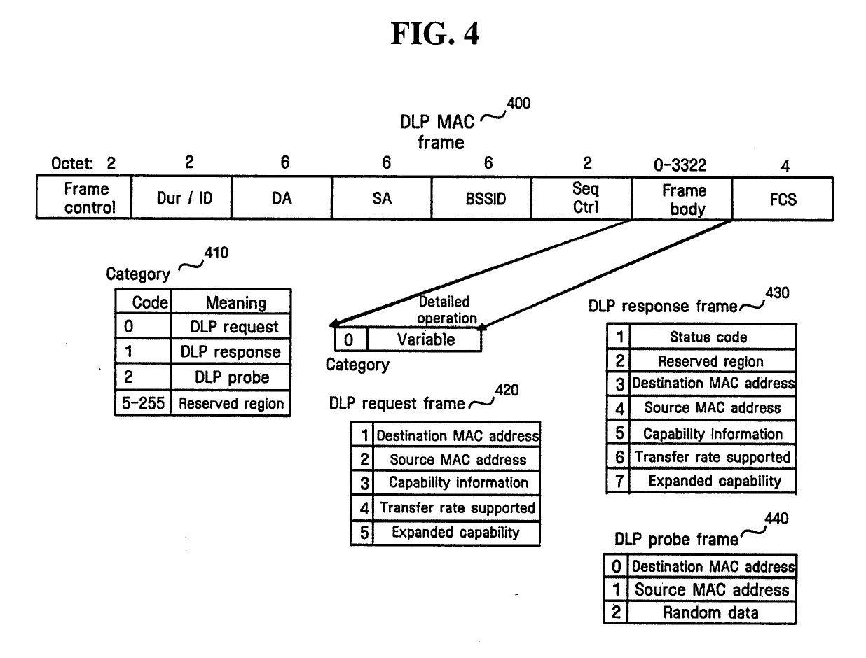

FIG. 6 shows the structure of a DLP MAC frame consistent with the present invention. As compared with the structure of the DLP MAC frame in the related art shown in FIG. 4, the external and general structure of the DLP MAC frame shown in FIG. 6 is the same as shown in FIG. 4. A MAC header section consists of a frame control field, a duration/ID (Dur/ID) field, a destination address (DA) field, a source address (SA) field, a basic service set ID (BSSID) field, and a sequence control (Seq Ctrl) field. A subsequent frame body section has a variable length and contains information on frame category and variables. Codes representing various kinds of frames to be described later are written in this category. Field values contained in various frames are stored in the variables. Further, a frame check sequence (FCS) field has IEEE 32-bit Cyclic Redundancy Check (CRC) information.

However, the kind of the category contained in the frame body section and the constituent fields of the DLP frame shown in FIG. 6 are different from those shown in FIG. 4. Category 410 will be first considered. It can be seen that a “DLP start” field 413 indicating the DLP start frame has been added to the category. Next, the DLP start frame 450 may consist of a MAC address field 451 of a destination station (receiving station), a MAC address field 452 of a source station (sending station), and a channel number field 453 of a channel through DLP communications are made.

The format of a DLP probe frame 440 is the same as a conventional one. This frame serves to check whether a direct link connection works well. This frame is not an indispensable one but an optional one.

A DLP request frame 420 is a frame by which a sending station requests a direct link before it transmits/receives data to/from a receiving station. If the DLP request frame is sent to the AP, the AP forwards this frame to the receiving station. Fields added to a conventional DLP request frame include a channel number field 425 that determines a channel through which direct link communications will be made, and a duration field 426 that determines the duration of the connection state established through the direct link. When the sending station initially transmits the DLP request frame to the AP, it cannot know an available channel number. Thus, the channel number is assigned a “NULL” value. Then, the AP finds an available channel number and then writes the value of the channel number in the channel number field 425 before forwarding the DLP request frame to the receiving station.

A DLP response frame 430 is a frame that is forwarded to the sending station by the AP when the receiving station receives the DLP request frame, determines whether to join the DLP direct link, and then transmits the DLP response frame to the AP. The results of determination on whether to join the direct link are shown in a status code field 431. A field added to a conventional DLP response frame is a channel number field 437 containing the channel number allocated by the AP to the channel number field 425 of the DLP request frame. The sending station can know the channel number to be connected through the direct link by referring to the channel number field 437 of the DLP response frame. Accordingly, both the sending and receiving stations can communicate with each other through a single channel.

FIG. 7 shows the structure of an association request frame. The association request frame 700 is constructed such that its head section includes a frame control field, a Dur/ID field, a DA field, an SA field, a BSSID field and a Seq Ctrl field, in the same manner as the DLP frame. The header section is followed by a frame body field 710 and a FCS field. Contrary to the DLP frame, the frame body field 710 consists of a capability information field 720, a listen interval field, an SSID field and a supported rates field. Further, the capability information field 720 includes sub-fields each of which contains bit information (0 or 1). The sub-fields further includes a CF Poll Request field 730 and a DLP Capable field 740.

In a case where an infrastructure mode is used, a station becomes a member of a BSS through association and can thus perform communications within the BSS. The station requests the association by transmitting the association request frame 700 to the AP. Then, the AP gives a chance for each station to transmit data through polling. While requesting the association, the station sets a DLP Capable field added to implement the present invention, i.e. the bit 740 informing whether the station supports a DLP, as well as the bit 730 informing whether the station can receive a poll, i.e. whether the station is CF Pollable, as a value of “1” or “0”, into the capability information field 720 of the association request frame 700. Then, the station informs the AP of the set results. Here, “1” indicates a TRUE value, and “0” indicates a FALSE value.

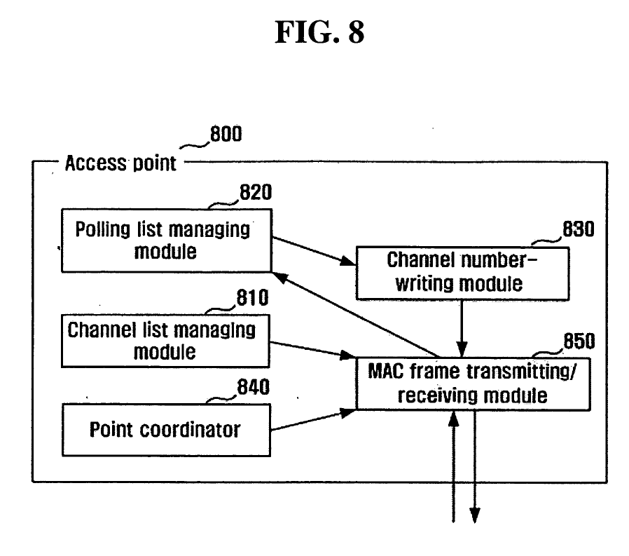

FIG. 8 illustrates the configuration of an AP 800 for implementing the present invention. As shown in this figure, the AP 800 may comprise a channel list-managing module 810, a polling list-managing module 820, a channel number-writing module 830, a point coordinator 840 and a MAC frame-transmitting/receiving module 850.

The polling list-managing module 820 manages a polling list table such as Table 1 to provide sequential polling. Here, a bit value of “1” indicates a TRUE value, while a bit value of “0” indicates a FALSE value.

It is first determined from the polling list table whether a DLP is supported. Then, only when the DLP is supported, a channel use list is confirmed. Thus, if a DLP station uses a channel other than the existing channel, the polling is not performed.

TABLE 1

| Station | CF Pollable/DLP Capable |
|---|---|
| STA1 | 1/1 |
| STA2 | 1/0 |
| STA3 | 1/1 |
| STA4 | 1/0 |

The channel list-managing module 810 manages a list of available channels through periodical channel condition analysis and distributes the list. Since channels are limited resources, the AP cannot distribute channels without restriction. The following table shows an example of a list of available channels existing in the AP. In such a way, the channel list-managing module 810 can manage a list of channels used in the BSS, including the primary channel, according to channel number. The AP manages and distributes the available channels in the channel list, excluding the primary channel used in the BSS, according to the order of less noise based on the received signal strength indication (RSSI).

TABLE 2

| Channel Number | Completion Time | Station List | RSSI |
|---|---|---|---|
| CH1 | Tch1 | S1, S2 | 10 |
| . . . | . . . | . . . | . . . |
| CHn | Tchn | S3, S4 | 5 |

The channel number-writing module 830 checks whether there are any distributable DLP channels when receiving a DLP request frame via the MAC frame-transmitting/receiving module 850, and then writes the checked distributable DLP channel into the DLP request frame.

If a frame that needs to be sent from another station to a DLP station is sent to the AP when the DLP station uses the other channel, the point coordinator 840 performs the buffering of the frame by considering the DLP station in the other channel as a sleeping station. Then, if the DLP station again uses the existing channels, the AP sends the buffered frame to the DLP station.

The MAC frame-transmitting/receiving module 850 receives a data frame transmitted via a primary channel from a transmitting station and forwards the received data frame to a receiving station. Further, the MAC frame-transmitting/receiving module 850 forwards a DLP request frame received from a DLP sending station to a DLP receiving station and forwards a DLP request frame received from the DLP receiving station to the DLP sending station.

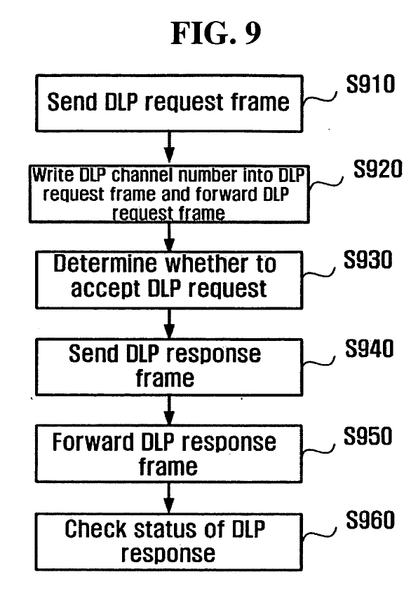

FIG. 9 illustrates a modified four-handshake process of implementing the present invention. If there is a station that intends to transmit data through a direct link, a DLP sending station creates a DLP request frame and then transmits the DLP request frame to an AP (S910). The AP periodically scans available channels and manages a list of the available channels. Upon distribution of the available channels, the AP distributes available channels except channels that are currently being used in a BSS. The AP writes one channel number of the available channels into the channel number field of the DLP request frame and then forwards the DLP request frame to a DLP receiving station (S920). The DLP receiving station determines whether to receive the DLP request (S930). Next, the DLP receiving station sends a DLP response frame including the determination results, to the AP (S940). The AP forwards the DLP response frame to the DLP sending station (S950). Finally, the DLP sending station checks the status of the DLP response, i.e., whether the DLP receiving station has rejected or accepted the direct link, based on the received DLP response frame (S960).

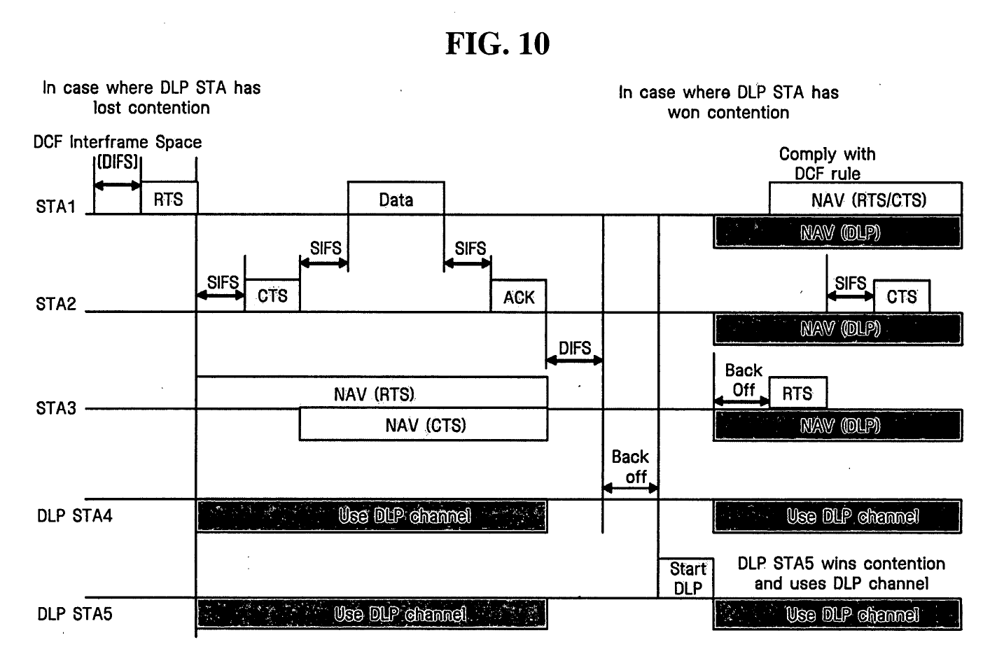

FIG. 10 shows a data transfer process for each station with the passage of time in a state where a BSS uses only DCF. If a station has lost contention against other stations in the BSS after the station joins the direct link using a DLP, the station does not wait for an NAV period but enhances the transfer rate in a DLP station by using a DLP channel. If the station does not transmit data to the DLP station but should communicate with other stations in the BSS, the station communicates with the other stations via a primary channel according to DCF rules. The other stations in the BSS also have more chances to use a channel since the chance of the DLP station to use the primary channel is reduced. On the other hand, if the DLP station has won the contention, the DLP station performs communications through the DLP channel without using the primary channel. The other stations in the BSS again contend with one another and comply with a basic contention algorithm of the DCF. FIG. 10 shows both cases where the DLP station has won and lost the channel contention. This method is advantageous in that communications between the DLP stations and general stations in a BSS can be made, the advantages of the DLP can be utilized, and an overall channel efficiency in the BSS can also be enhanced.

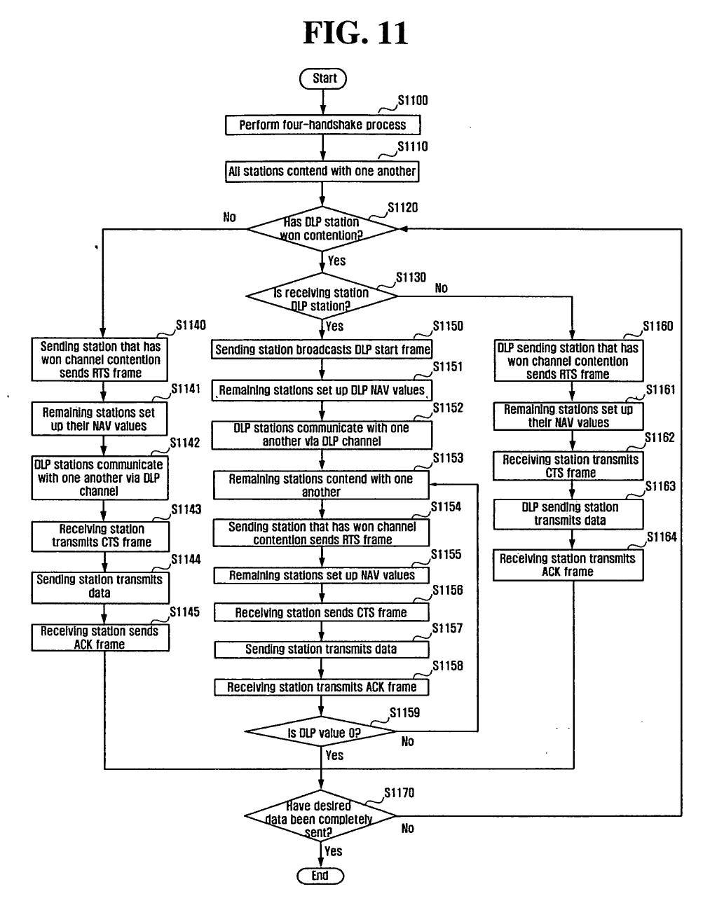

FIG. 11 is a flowchart illustrating the operating process when a BSS uses only a DCF. A four-handshake process as shown in FIG. 9 is first executed (S1100). Then, all stations contend with one another for a channel (S1110). The process is divided into two cases where a DLP station has won or lost primary channel contention (S1120). When the DLP station has won the channel contention, a receiving station may be either a DLP station that is connected through a direct link or a general station that is not connected through a direct link. For this reason, the case where the DLP station has won the channel contention will be divided into two cases according to whether the receiving station is a DLP station or not (S1130).

First, in the case where the DLP station has lost the primary channel contention, the sending station that has won the channel contention sends a RTS frame to a receiving station (S1140) and the remaining stations except for the DLP station set up their NAV values (S1141). During the period corresponding to the set NAV value, the DLP stations communicate with one another using a DLP channel (S1142). The receiving station transmits a CTS frame to the sending station (S1143). Then, the sending station transmits data to the receiving station (S1144) and the receiving station sends an ACK frame to the sending station (S1145).

Second, in the case where the DLP station has won the primary channel contention and the receiving station is a DLP station, the DLP sending station first broadcasts a DLP start frame to inform all the remaining stations that DLP communication has started (S1150). The remaining stations set up NAV values (hereinafter, referred to as “DLP NAV”) during the period that is reserved for communications by the DLP station and thus are in a state where communications cannot be made through the DLP channel (S1151). The DLP stations communicate with one another using a DLP channel (S1152). Meanwhile, since the primary channel is still empty, the remaining stations can contend with one another for the channel (S1153).

As a result of the contention, a sending station that has won the channel contention sends a RTS frame to a receiving station (S1154). The stations other then the DLP sending/receiving stations and the sending/receiving stations established through the channel contention set up their NAV values (S1155). Thereafter, the receiving station sends a CTS frame to the sending station (S1156) and the sending station sends data to the receiving station accordingly (S1157). Then, the receiving station transmits an ACK frame to the sending station (S1158). During the period where the DLP NAV is set up, the above process of S1153 to S1158 is repeated (S1159).

Finally, in the case where a DLP station has won the primary channel contention and the receiving station is not a DLP station, the process is the same as the channel contention scheme of the general station other than the DLP station (S1160 to S1164).

If desired data are completely transmitted in the last steps of the three cases, the process is terminated. If desired data are not completely transmitted, the process is repeated from the first step in which all the stations contend with one another for a channel (S1170).

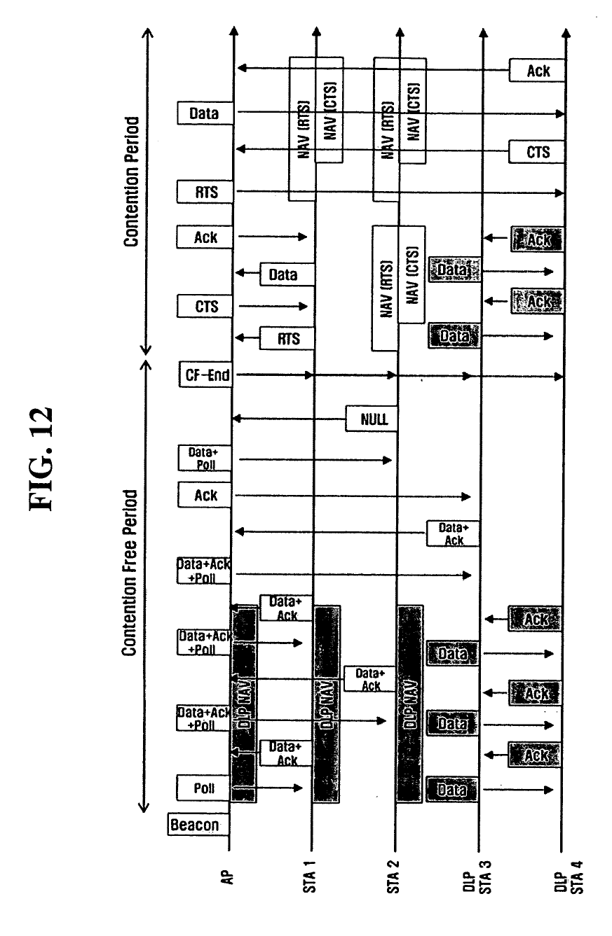

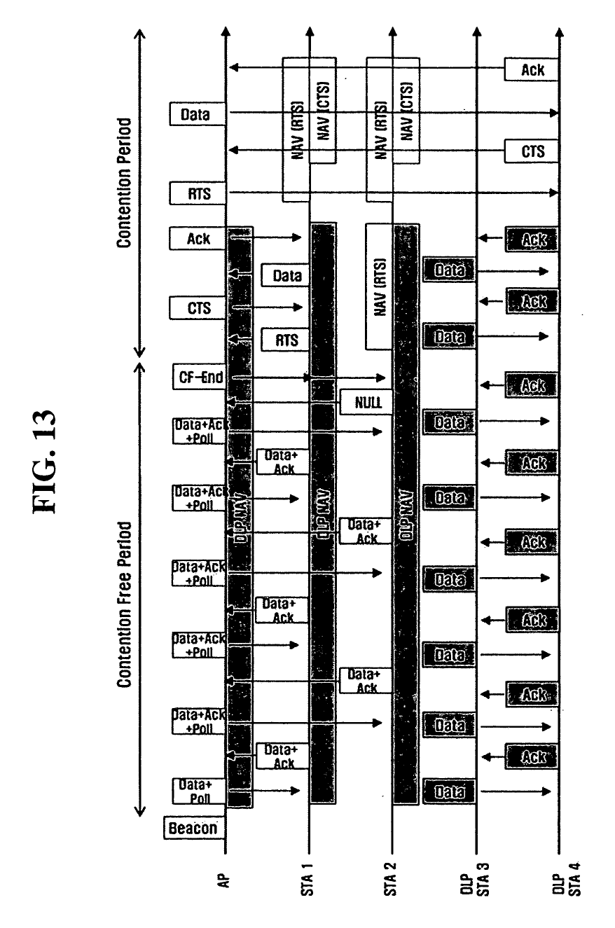

FIGS. 12 and 13 show a data transfer process for each station with the passage of time in a case where a BSS uses both PCF and DCF. In particular, FIG. 12 shows a data transfer process in which a time point when a station returns to the primary channel after using a DLP channel is within a PCF period and FIG. 13 shows a data transfer process in which a time point when the station returns to the primary channel after using the DLP channel is within a DCF period. When the BSS uses both PCF and DCF, a DLP setup process, i.e. a DLP four-handshake process is first performed. Then, DLP stations exchange data with one another during a DLP NAV period. Such a DLP NAV period is determined by the value of the duration field 426 (FIG. 6) that determines the DLP NAV period in the four-handshake process.

During a Contention Free Period (CFP) period, an AP sequentially sends a poll from a polling list. At this time, if a station is not CF Pollable, the AP does not send a poll. If the station is CF Pollable, the AP checks whether the station is DLP Capable. If the station is DLP Capable, the AP checks a channel list of the AP and sends the poll to the station after confirming that the DLP station uses an existing primary channel other than a DLP channel. Therefore, when the DLP station uses the DLP channel, general stations have more chances to take a poll and thus to transmit data.

The stations attempt to contend with one another for a channel according to PCF/DCF. According to the PCF, the AP transmits a beacon to all stations in a BSS every target beacon transmission time (TBTT) period. Further, as the beacon starts its broadcast, the PCF and DCF periods are performed in a super frame according to information contained in the beacon. The DLP NAV period, i.e. a period of communication through the DLP channel, is informed to all the stations through the beacon. During this period, the DLP stations are switched to DLP channels to exchange data with one another. At this time, a mechanism for switching the DLP station to an existing channel is determined by comparing the DLP NAV period with a CFP period (CFPDurRemaining) value of a beacon frame representing the CFP period. If the DLP NAV value is less than the CFPDurRemaining value, the DLP stations will be switched to the existing channel in the PCF period. However, if the DLP NAV value is greater than the CFPDurRemaining value, the DLP stations will switch to the existing channel in the DCF period.

If the DLP stations are switched to the existing channel within the PCF period complying with the PCF rules as shown in FIG. 12, all the stations including the DLP stations comply with a PCF mechanism in which the stations receive polls from the AP and communicate with one another during the remaining PCF period. Then, during the DCF period, all the stations communicate with one another while contending with one another according to the DCF rules. Otherwise, they switch to DLP channels through the channel contention in a manner such as the case where only the DCF is used as shown in FIGS. 10 and 11, and then perform data communications.

On the other hand, if the DLP stations are switched to the existing channel in the DCF period as shown in FIG. 13, all the stations communicate with one another while contending with one another according to DCF rules during the remaining DCF period. Otherwise, they are switched to the DLP channel through channel contention in a manner such as the case where only DCF is used as shown in FIGS. 10 and 11, and then perform data communications.

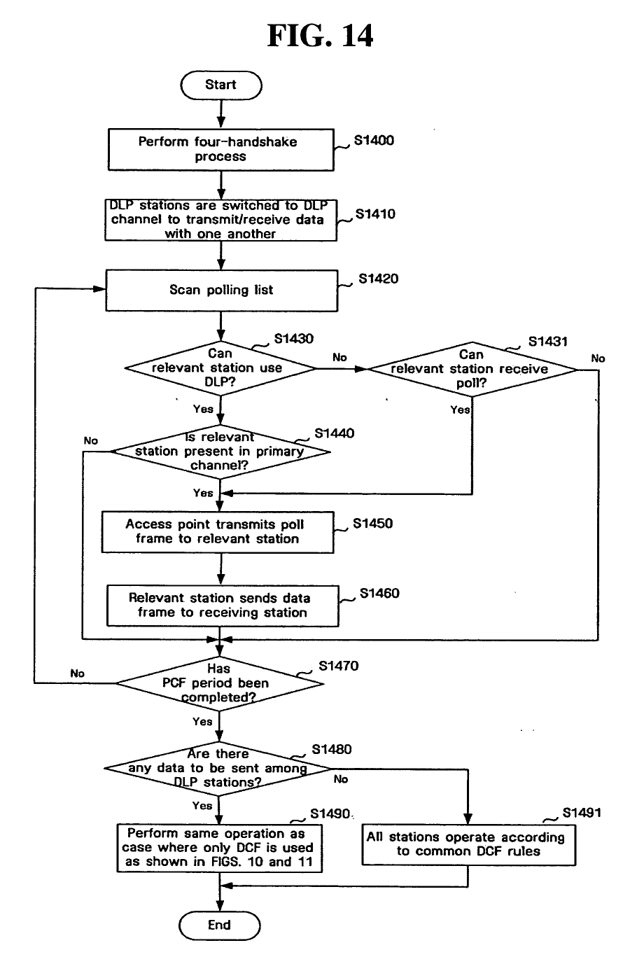

FIG. 14 is a flowchart illustrating the operating process in which DLP stations are switched to an existing primary channel in a PCF period in a state where a BSS uses both PCF and DCF. In the PCF period, the DLP stations are switched to an independent channel during a DLP NAV period according to a beacon indicating the start of a super frame. If the DLP NAV period is ended, all the stations operate according to a PCF polling mode during the remaining PCF period. Thereafter, during the DCF period, the stations switch to a DLP channel through channel contention and then perform data communications, in the same manner as the case where only DCF is used (refer to FIGS. 10 and 11).

A four-handshake process such as shown in FIG. 9 is first performed (S1400). Then, DLP stations perform synchronization for channel switching through a beacon. The DLP stations switch to an independent DLP channel and then perform data communications (S1410). The channel switching process corresponds to a process in which the channel-switching module 520 (FIG. 5) switches the DLP station to a channel allocated by the channel list-managing module 810 (FIG. 8) of the AP. The period during which data are transmitted/received via the DLP channel among DLP stations corresponds to the duration 426 (FIG. 6) written into the DLP request frame.

In the PCF period, the AP causes the polling list-managing module 810 (FIG. 8) to determine a polling sequence and whether it polled the stations, based on a polling list. The polling list-managing module 810 (FIG. 8) finds out whether a station associated through the CF Pollable bit 730 of the association request frame 700 (FIG. 7) can receive a poll and whether the associated station can use a DLP through the DLP Capable bit 740, and then writes the results into the polling list.

The polling list-managing module scans the polling list (S1420) and determines whether a relevant station can use a DLP (i.e., “DLP Capable”) (S1430). If it is determined in S1430 that the relevant station can use DLP, the module will determine whether the relevant station exists in a primary channel (S1440). If the relevant station exists in the primary channel, the AP transmits a poll frame to the relevant station (S1450). A relevant station that receives the poll sends a data frame to the AP, which in turn forwards the received data frame to a receiving station (S1460). In such a case, a station that receives the poll frame or data frame sends an ACK frame to a sending station so that it can be confirmed whether the poll frame or data frame has been correctly received. If it is determined in S1440 that a relevant station is not present in the primary channel, the AP does not poll the relevant station because the station uses an independent DLP channel.

If it is determined in S1430 that the relevant station cannot use DLP, the AP determines whether the relevant station can receive the poll (i.e., “CF Pollable”) (S1431). If the relevant station cannot receive the poll, the AP does not poll the relevant station. Meanwhile, if the relevant station can receive the poll, the above steps S1450 and S1460 are performed for the relevant station. Then, the steps S1420 to S1460 are repeated until the PCF period is ended (S1470). If a DCF period is started after the PCF period is ended, it is determined whether there are any data to be sent among DLP stations (S1480). If there are data to be sent among DLP stations, the same operation as the case where only the DCF is used (FIGS. 10 and 11) is performed (S1490). If there are no data to be sent, all the stations operate while contending with one another according to common DCF rules (S1491).

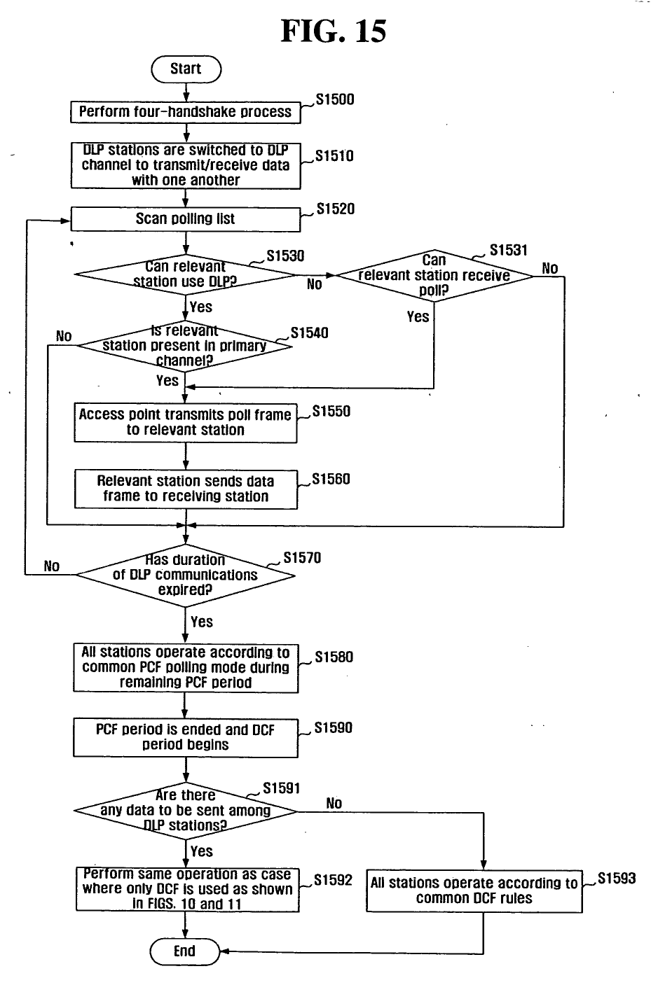

FIG. 15 is a flowchart illustrating the operating process in which DLP stations are switched to an existing primary channel in a DCF period in the case where a BSS uses both PCF and DCF. In the PCF period, DLP stations are switched to an independent channel during a DLP NAV period according to a beacon indicating the start of a super frame. During the remaining DCF period, the stations switch to a DLP channel through the channel contention as in the case where only the DCF is used (FIGS. 10 and 11) and perform data communications. The steps S1500 to S1560 of FIG. 15 are the same as the steps S1400 to S1460 of FIG. 14. However, it is determined after the step S1560 whether the duration of DLP communications specified in the four-handshake process has expired (S1570).

Until the duration of DLP communications has expired, the steps S1520 to S1560 are repeated. On the other hand, if it is determined that the duration of DLP communications has expired, all the stations operate according to a common PCF polling mode during the remaining PCF period (S1580). Then, it is determined in the DCF period whether there are any data to be sent among DLP stations (S1591). If there are data to be sent among DLP stations, the same operation as the case where only the DCF is used (FIGS. 10 and 11) is performed (S1592). If there are no data to be sent, all the stations operate while contending with one another according to common DCF rules (S1593).

Consistent with the present invention, there is an advantage in that compatible wireless environments can be provided such that stations use either a DCF or PCF or an independent direct link suitable for their operating conditions.

Further, there is another advantage in that high bandwidth can be obtained by reducing contentions among the stations using DCF and increasing the chances to take a poll among the stations using PCF.

In addition, there is a further advantage in that QoS can be enhanced since a stable throughput can be ensured when P2P communications are needed among stations in a BSS.

Although the embodiments of the present invention have been described with reference to the accompanying drawings, it can be understood by those skilled in the art that the present invention can be implemented in the other specific forms without modifying or changing the technical spirit and essential features thereof. Therefore, it should be understood that the aforementioned embodiments are not restrictive but illustrative in all aspects. The scope of the present invention should be defined by the appended claims, and all changes or modifications made from the spirit and scope of the invention and equivalents thereof should be construed as falling within the scope of the invention.

1. A wireless network communication method using an access point in an infrastructure mode in which both contention-free and contention periods are used, comprising:
(1) transmitting/receiving data among direct link protocol (DLP) stations, during a given duration, through the direct link using an independent channel;
(2) transmitting/receiving data among stations other than the DLP stations, during the duration, in a specific mode corresponding to the contention-free or contention period;
(3) switching the DLP stations to a primary channel after the given duration; and
(4) transmitting/receiving data among all stations including the DLP stations, during the remaining duration, in a specific mode corresponding to the contention-free or contention period.

2. The wireless network communication method as claimed in claim 1, wherein the independent channel is a channel of which noise based on received signal strength indication (RSSI) is smallest among channels in a channel list of the access point except for the primary channel.

3. The wireless network communication method as claimed in claim 1, further comprising a setup process of enabling direct link communications prior to transmitting/receiving data among the DLP stations, during a given duration, through the direct link using an independent channel, wherein the setup process comprises:
transmitting a DLP request frame to the access point;
writing a number of a channel for the direct link communications into the DLP request frame and forwarding the DLP request frame;
determining whether to accept a request for the direct link communications; and
transmitting a response frame comprising determination results for the request for the direct link communications.

4. The wireless network communication method as claimed in claim 1, wherein a communication mode in the contention-free period is a polling mode by the access point.

5. The wireless network communication method as claimed in claim 4, wherein the polling mode comprises:
(a) scanning a polling list by the access point;
(b) determining whether a relevant station can use the direct link;
(c) if it is determined in (b) that the relevant station can use the direct link, determining whether the relevant station is present in the primary channel; and
(d) if it is determined in (c) that the relevant station is present in the primary channel, transmitting the data, by the relevant station, after the relevant station has received a poll from the access point.

6. The wireless network communication method as claimed in claim 5, further comprising, if it is determined in transmitting/receiving data among the stations other than the DLP stations, during the duration, in a specific mode corresponding to the contention-free or contention period that the relevant station cannot use the direct link, transmitting data, by the relevant station, after the station has received a poll from the access point when the relevant station is a station that can receive the poll.

7. The wireless network communication method as claimed in claim 5, wherein a field of an association request frame that will be sent to the access point when the station participates in the wireless network, which contains information on whether the station supports the direct link, is used to determine whether the corresponding station can use the direct link.

8. The wireless network communication method as claimed in claim 1, further comprising, if the stations other than the DLP stations have any data to be sent to a specific station of the DLP stations during the duration, performing buffering and management of the data and transmitting the data to the specific station, by the access point, after the duration.

9. The wireless network communication method as claimed in claim 1, wherein a process of performing data communications during the contention period after the duration comprises:
contending with one another for a channel during the contention period, by predetermined stations;
when a station that has won the contention is a station that wishes to perform the direct link communications, allocating one available channel in a predetermined channel list to the station for the direct link communications; and
contending with one another via the primary channel during the duration of the direct link communications, by stations other than the DLP station to which the channel for the direct link communications has been allocated.

10. The wireless network communication method as claimed in claim 1, wherein a process of performing data communications during the contention period after the duration comprises:
contending with one another for a channel during the contention period, by predetermined stations;
when a station that has won the contention is not a station that wishes to perform the direct link communications, allocating one available channel in a predetermined channel list to the station for the direct link communications;
contending with one another, by the stations that wish to perform the direct link communications, via the allocated channel during the period when the station that has won the contention performs the communications; and
contending with one another via the primary channel after the duration, by all stations.

11. A communication station operable to perform wireless network communications using an access point in an infrastructure mode in which both contention-free and contention periods are used, comprising:
a channel-switching module that switches an existing channel to an independent channel by writing a new channel number into a DLP request frame; and
a MAC frame-generating module that generates a predetermined MAC frame comprising the DLP request frame.

12. The communication station as claimed in claim 11, further comprising a MAC frame transmitting/receiving module that transmits the predetermined MAC frame generated by the MAC frame-generating module and receives various MAC frames from the access point or other stations.

13. An access point operable to be used in communications among stations in an infrastructure mode in which both contention-free and contention periods are used, comprising:
a polling list-managing module that provides sequential polling to the stations based on a polling list;
a channel list-managing module that manages a list of available channels through periodical channel condition analysis and allocates an independent channel to a station which perform communications through a direct link DLP station;
a channel number-writing module that determines whether there are available channels based on the channel list and writes the available channels into a frame requesting the direct link DLP request frame; and
a point coordinator that receives frames to be sent to the DLP stations that perform communications through the direct link from stations present in a primary channel and performs buffering and management for the received frames.

14. The access point as claimed in claim 13, further comprising a MAC frame transmitting/receiving module that receives the DLP request frames or frames responding to the request for the direct link communications, and then sends again the frames to other stations.

15. The access point as claimed in claim 13, where the independent channel is a channel of which noise based on received signal strength indication (RSSI) is smallest among channels in a channel list of the access point except for the primary channel.

16. The access point as claimed in claim 13, wherein the polling mode is executed by scanning a polling list; determining whether a relevant station can use the direct link; determining whether the relevant station is present in the primary channel, when it is determined that the relevant station can use the direct link; and transmitting the data, by the relevant station, after the relevant station has received a poll from the access point, when it is determined that the relevant station is present in the primary channel.

17. The access point as claimed in claim 16, wherein if it is determined that the relevant station cannot use the direct link, the relevant station receives a poll from the access point and then transmits the data when the relevant station is a station that can receive the poll.

18. The access point as claimed in claim 16, wherein a field of an association request frame that will be sent to the access point when the station participates in the wireless network, which contains information on whether the station supports the direct link, is used to determine whether the relevant station can use the direct link.

19. A recording medium in which a program for executing a method as claimed in claim 1 is recorded in computer-readable format.
